(19) United States
(12) Patent Application Publication
(10) Pub. No.: US 2025/0305437 A1
(43) Pub. Date: Oct. 2, 2025

(54) VEHICLE THERMAL MANAGEMENT DEVICE, VEHICLE THERMAL MANAGEMENT METHOD, AND RECORDING MEDIUM

(71) Applicant: Panasonic Automotive Systems Co., Ltd., Kanagawa (JP)

(72) Inventors: Takumi MOTEKI, Kanagawa (JP); Toshihiro OKUDA, Tokyo (JP); Nobumichi YASUNAMI, Kanagawa (JP); Yuki IIDA, Kanagawa (JP); Kiyokazu SHIKANO, Kanagawa (JP)

(73) Assignee: Panasonic Automotive Systems Co., Ltd., Kanagawa (JP)

(21) Appl. No.: 19/058,824

(22) Filed: Feb. 20, 2025

(30) Foreign Application Priority Data
Mar. 29, 2024 (JP) 2024-056228

(51) Int. Cl. F01P 3/20; B60Q 9/00; F01P 7/14

(52) U.S. Cl. CPC F01P 3/20; B60Q 9/00; F01P 7/14; F01P 2025/60

(57) ABSTRACT

A vehicle thermal management device includes: an acquirer that acquires driver behavior information indicating a driver behavior and at least one of vehicle information indicating a state of a vehicle or surroundings information indicating surroundings of the vehicle; an identifier that identifies, based on the driver behavior information and the at least one of the vehicle information or the surroundings information, a scene in which a power consumption of a control unit provided in the vehicle corresponding to the driver behavior information is predicted to increase to be higher than an ideal power consumption; and a controller that executes power increase suppression control for suppressing an increase in the power consumption of the control unit in the scene that is identified by the identifier and in which the power consumption of the control unit is predicted to increase to be higher than the ideal power consumption.

### CROSS REFERENCE TO RELATED APPLICATION

The present application is based on and claims priority of Japanese Patent Application No. 2024-056228 filed on Mar. 29, 2024.

### FIELD

The present disclosure relates to a vehicle thermal management device mounted on a vehicle, a vehicle thermal management method, and a recording medium.

### BACKGROUND

Patent Literature (PTL) 1 discloses a method and a device for carrying out open loop control/closed loop control on a heat flow generated by an engine cooling system mounted on an automobile by predicting an upcoming load state of the engine cooling system based on a model that takes a thermal inertia of the engine cooling system into consideration and an upcoming engine-load-relevant ambient condition in a detected driving direction.

### CITATION LIST

### Patent Literature

PTL 1: Japanese Unexamined Patent Application Publication (Translation of PCT Application) No. 2003-514184

### SUMMARY

However, the method and the device according to PTL 1 can be improved upon.

In view of this, the present disclosure provides a vehicle thermal management device and the like capable of improving upon the above related art.

A vehicle thermal management device according to one aspect of the present disclosure includes: an acquirer that acquires driver behavior information that indicates a driver behavior of a driver that is related to a driving operation of a vehicle and at least one of vehicle information that indicates a state of the vehicle that the driver drives or surroundings information regarding surroundings of the vehicle; an identifier that identifies, based on the driver behavior information and the at least one of the vehicle information or the surroundings information, a scene in which a power consumption of a control unit provided in the vehicle that corresponds to the driver behavior information is predicted to increase to be higher than an ideal power consumption; and a controller that executes power increase suppression control for suppressing an increase in the power consumption of the control unit in the scene that is identified by the identifier and in which the power consumption of the control unit is predicted to increase to be higher than the ideal power consumption.

The vehicle thermal management device and the like according to one aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram of a vehicle thermal management device according to an embodiment of the present disclosure.

FIG. 2 is a diagram showing vehicle information and surroundings information for each scene.

FIG. 3A is a diagram showing driver behavior information for each scene.

FIG. 3B is a diagram showing a behavior history.

FIG. 4 is a diagram showing a relationship between (i) a scene in which a vehicle runs, (ii) a driver behavior, and (iii) a power consumption of a control unit.

FIG. 5 is a diagram showing a power consumption, a heat dissipation ability, and a heat source temperature according to a comparative example and a power consumption, a heat dissipation ability, and a heat source temperature according to the present embodiment.

FIG. 6 is a flowchart illustrating an example of an operation performed by the vehicle thermal management device.

### DESCRIPTION OF EMBODIMENT

Hereinafter, an embodiment will be described specifically with reference to the drawings.

The embodiment described below shows a generic or specific example of the present disclosure. The numerical values, shapes, materials, structural elements, the arrangement and connection of the structural elements, steps, the order of the steps, and the like shown in the following embodiment are merely examples, and therefore are not intended to limit the scope of the present disclosure. Also, among the structural elements described in the following embodiment, structural elements not recited in any one of the independent claims are described as arbitrary structural elements.

In addition, the diagrams are schematic representations, and thus are not necessarily true to scale. Also, in the diagrams, structural elements that are the same are given the same reference numerals.

### EMBODIMENT

### <Configuration and Function>

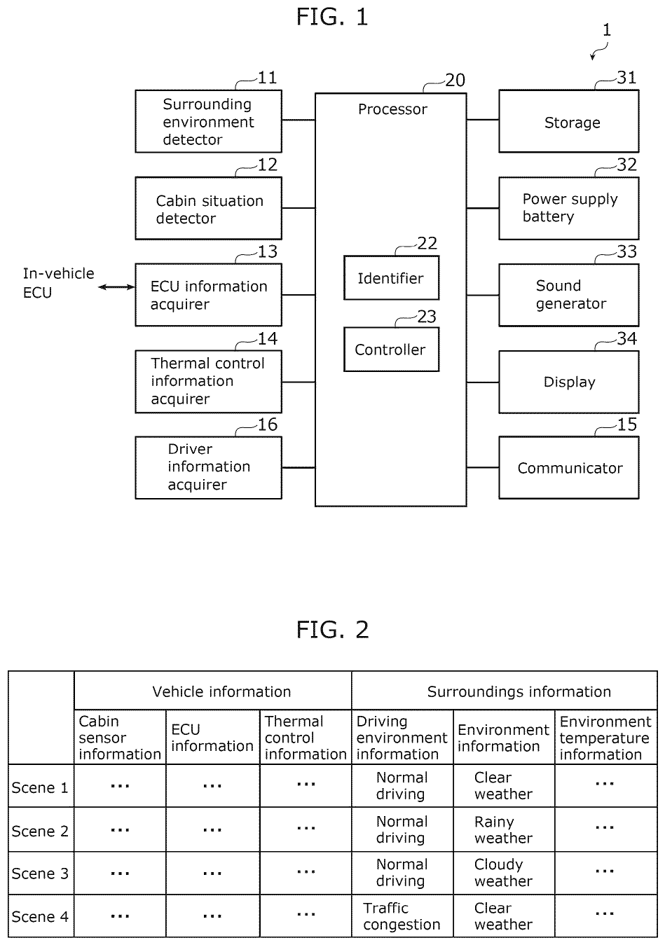

Hereinafter, a configuration of vehicle thermal management device 1 to an embodiment will be described with reference to FIGS. 1 to 3B.

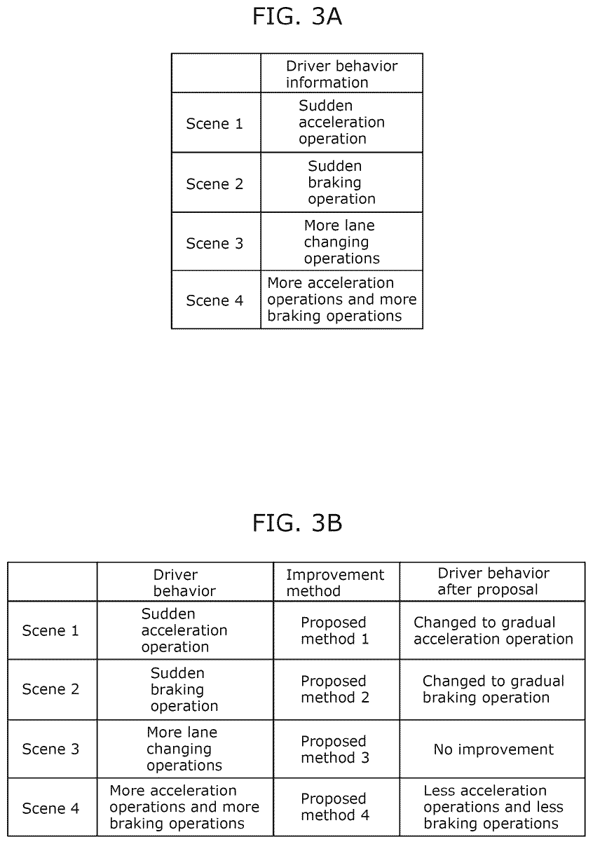

FIG. 1 is a block diagram of vehicle thermal management device 1 according to the present embodiment. FIG. 2 is a diagram showing vehicle information and surroundings information for each scene. FIG. 3A is a diagram showing driver behavior information for each scene. FIG. 3B is a diagram showing a behavior history.

As shown in FIG. 1, in vehicle thermal management device 1, heat dissipation control of a control unit mounted on a vehicle can be optimized by taking a driver behavior of a driver who is operating the vehicle into consideration. The control unit includes an integrated circuit and a processor that constitute an electronic control unit (ECU) and the like of the vehicle. The heat dissipation control includes control of a power consumption of the control unit and control of a heat dissipation ability of the control unit.

Vehicle thermal management device 1 includes surrounding environment detector 11, cabin situation detector 12, ECU information acquirer 13, thermal control information acquirer 14, driver information acquirer 16, communicator 15, processor 20, a notifier, storage 31, and power supply battery 32.

As shown in FIGS. 1 and 2, surrounding environment detector 11 is a temperature sensor or the like provided in the vehicle, and can acquire environment temperature information. Surrounding environment detector 11 may detect a detection target around the vehicle. Examples of the detection target include mobile objects such as a pedestrian and another vehicle, obstacles such as an installed object, and the like. Detection target information that indicates the detection target may be included in surroundings information. The environment temperature information is information that indicates a temperature (air temperature) around the vehicle. The environment temperature information is included in the surroundings information that indicates the surroundings of the vehicle. Surrounding environment detector 11 is an example of an acquirer.

Cabin situation detector 12 is an in-vehicle sensor mounted on a cabin of the vehicle, and can acquire cabin sensor information regarding an interior of the cabin of the vehicle. The cabin sensor information includes information regarding the number of passengers on the vehicle, and the like. The cabin sensor information is included in vehicle information regarding the vehicle that the driver drives. Cabin situation detector 12 is an example of an acquirer.

ECU information acquirer 13 can acquire ECU information from an in-vehicle ECU. The ECU information includes: current location information that indicates a current location of the vehicle based on map information around the vehicle; route information that indicates a destination and a driving route of the vehicle; information that indicates an ambient temperature around the control unit; driving control information that indicates driving control; and the like. The driving control information includes acceleration control based on an acceleration operation, deceleration control based on a braking operation, and steering control based on a steering operation such as changing the lane or turning right or left. The ECU information is included in the vehicle information regarding the vehicle. ECU information acquirer 13 is an example of an acquirer.

Thermal control information acquirer 14 can acquire thermal control information that indicates thermal control of the control unit. The thermal control information includes the power consumption of the control unit, the heat dissipation ability of the control unit, and the like. The thermal control information that indicates thermal control of the control unit is included in the vehicle information regarding the vehicle. Thermal control information acquirer 14 is an example of an acquirer. The thermal control of the control unit is performed by controller 23 controlling a cooling ability of at least one of a cooling fan, a water cooler, a water pump, or a peltier element for cooling the control unit.

Driver information acquirer 16 acquires driver behavior information regarding the behavior of the driver who is operating the vehicle. Driver information acquirer 16 is an in-vehicle camera, such as a driver camera, installed in the cabin of the vehicle, an input terminal with which the driver can manually input his/her behavior, or the like. The driver behavior information indicates a driver behavior that is related to a driving operation of the vehicle. Examples of the driver behavior include an acceleration operation, a braking operation, a steering operation, a lane changing operation, and the like. Driver information acquirer 16 is an example of an acquirer.

Communicator 15 is a communication module provided in the vehicle, and can acquire environment information and driving environment information that indicates a driving environment around the vehicle. The environment information is information that indicates a weather and a climate of a region in which the vehicle is present. The weather and the climate of the region in which the vehicle is present can be acquired from, for example, the automated meteorological data acquisition system (AMeDAS) of the Japan Meteorological Agency. The driving environment information is road information determined based on the vehicle's global positioning system (GPS) information such as the traffic congestion of the region in which the vehicle is present, traffic control points, and the type of road. The driving environment information can be acquired in real time from, for example, a server installed in a road traffic information communication system center. The type of road includes highway, roadway, tunnel, and the like. The environment information and the driving environment information are included in the surroundings information that indicates the surroundings of the vehicle. Communicator 15 is an example of an acquirer.

In the present embodiment, surrounding environment detector 11, cabin situation detector 12, ECU information acquirer 13, thermal control information acquirer 14, communicator 15, and driver information acquirer 16 may also be referred to collectively as simply “acquirer”.

Processor 20 includes identifier 22 and controller 23.

Identifier 22 acquires the driver behavior information, the vehicle information, and the surroundings information from the acquirer including surrounding environment detector 11, cabin situation detector 12, ECU information acquirer 13, thermal control information acquirer 14, communicator 15, driver information acquirer 16, and the like.

Identifier 22 identifies, based on the driver behavior information and at least one of the vehicle information or the surroundings information, a scene in which the power consumption of the control unit provided in the vehicle that corresponds to the driver behavior information is predicted to increase to be higher than an ideal power consumption. That is, identifier 22 analyzes, based on the driver behavior information and at least one of the vehicle information or the surroundings information, the correlation between the driver behavior and the power consumption of the control unit, and identifies a scene in which, due to the driver behavior, the power consumption of the control unit is predicted to increase to be higher than the ideal power consumption. By doing so, identifier 22 associates the driver behavior indicated by the driver behavior information, the power consumption of the control unit indicated by the vehicle information, and the scene in which the power consumption of the control unit is predicted to increase to be higher than the ideal power consumption with each other.

As used herein, the term “scene” indicates a state in which the vehicle is in. For example, the scene includes at least one of the cabin sensor information included in the vehicle information, the current location information that indicates the current location of the vehicle, the route information, the information that indicates the ambient temperature around the control unit, the driving control information that indicates driving control, the thermal control information, the environment temperature information included in the surroundings information, the environment information, or the driving environment information.

FIG. 2 shows scenes 1 to 4 as examples. For each of scenes 1 to 4, the cabin sensor information, the ECU information, and the thermal control information (the power consumption of the control unit) that are included in the vehicle information, and the driving environment information, the environment information, and the environment temperature information that are included in the surroundings information are shown. FIG. 2 merely shows examples of scenes, and thus the scenes are not limited to those shown in FIG. 2.

The term “ideal power consumption” refers to power consumption that is considered to be ideal for the control unit in each scene. For example, when the driver excessively performs an acceleration operation, a braking operation, a steering operation, a lane changing operation, or the like in a specific scene, it is considered that the power consumption of the control unit increases to be higher than the ideal power consumption. In this case, in the specific scene, the power consumption of the control unit increases to be higher than the ideal power consumption.

Also, it is considered that the frequency of use of in-vehicle equipment increases as the number of passengers on the vehicle increases, and the power consumption of the control unit increases. For this reason, the power consumption of the control unit and the ideal power consumption are determined by taking the cabin sensor information (the number of passengers) into consideration. The in-vehicle equipment includes, for example, an in-vehicle camera, an air conditioner, a sound generating device, a navigation device, and the like. The navigation device may have an infotainment function that can be used by the passengers for entertainment.

As shown in FIG. 3A, identifier 22 associates the identified scene in which the power consumption of the control unit is predicted to increase to be higher than the ideal power consumption with the driver behavior, and outputs the associated information to controller 23.

Controller 23 executes power increase suppression control for suppressing an increase in the power consumption of the control unit in the identified scene in which the power consumption of the control unit is predicted to increase to be higher than the ideal power consumption.

The power increase suppression control includes control that causes the notifier to notify the driver of a proposed improvement method for improving the driver behavior in the scene identified by identifier 22 in which the power consumption of the control unit is predicted to increase to be higher than the ideal power consumption. Controller 23 causes the notifier to notify the driver of a proposed improvement method for improving the driver behavior in the scene in which the power consumption of the control unit is predicted to increase to be higher than the ideal power consumption. Specifically, controller 23 controls the notifier to notify the driver of the identified scene in which the power consumption of the control unit is predicted to increase to be higher than the ideal power consumption and a driver behavior that corresponds to the identified scene. Controller 23 determines, by controlling the notifier, an improvement method that corresponds to the identified scene in which the power consumption of the control unit is predicted to increase to be higher than the ideal power consumption from an improvement method stored in storage 31 in advance for each scene, and causes the notifier to notify the driver of the determined improvement method.

For example, in a situation where the driver performs a sudden moving operation, controller 23 causes the notifier to notify the driver of an improvement method that prompts the driver to gradually reduce the amount of accelerator pedal pressed. In a situation where the driver performs a sudden stopping operation, controller 23 causes the notifier to notify the driver of an improvement method that prompts the driver to gradually reduce the amount of brake pedal pressed and more quickly press the brake pedal. In another example, in a situation where a driver behavior history indicates that, during the time when the driver is listening to music, the driver drives calmly without performing a sudden moving operation or a sudden stopping operation, controller 23 causes the notifier to notify the driver of a notification that prompts the driver to listen to music. As described above, controller 23 causes the notifier to not only simply notify the driver of a notification that prompts the driver to stop a sudden moving operation or a sudden stopping operation, but also a proposed improvement method that improves the driver behavior.

The notifier includes sound generator 33 and display 34. In the present embodiment, the notifier includes sound generator 33 and display 34, but may include only either one of sound generator 33 or display 34.

Sound generator 33 is an in-vehicle loudspeaker provided in the vehicle. Sound generator 33 can output the improvement method using voice under control of controller 23.

Display 34 is a monitor provided in the vehicle. Display 34 can output the improvement method using a display image such as characters and pictures under control of controller 23.

Sound generator 33 and display 34 do not necessarily need to be provided in the vehicle. In the present embodiment, sound generator 33 and display 34 that are installed by being connected to the vehicle are also included in the notifier.

Controller 23 can determine, by controlling the notifier, a timing at which controller 23 causes the notifier to notify the driver of the improvement method. Specifically, controller 23 causes the notifier to notify the driver of the improvement method at a timing at which safety can be sufficiently ensured, a timing at which an effect expected from notification of the improvement method is obtained, or a timing suitable for improving driver's motivation.

The timing at which safety can be sufficiently ensured is, for example, before driving the vehicle. It is considered that, when the driver changes lanes while the vehicle is driving on a heavy traffic road, the driving load on the driver is high before and after the vehicle merges into the main line of a highway. If the notifier notifies the driver of the improvement method at such a timing, driver's attention is distracted, and safety may be impeded. For this reason, it is preferable to notify the driver of the improvement method before driving the vehicle so that safety can be sufficiently ensured. Also, by notifying the driver of the improvement method before driving the vehicle, it can be expected that the driver will recognize, out of the entire driving route of the vehicle, scenes in which the power consumption of the control unit is predicted to increase to be higher than the ideal power consumption due to driver behavior characteristics (habits).

The timing at which an effect expected from notification of the improvement method is obtained is, for example, before or during the time (in real-time) when the vehicle drives into a scene in which the power consumption of the control unit is predicted to increase to be higher than the ideal power consumption.

The timing suitable for improving driver's motivation is, for example, after driving the vehicle. By scoring the driver behavior throughout the day after driving the vehicle and notifying the driver of the score, it can be expected that the driver's motivation will be improved.

Also, when the identified scene is a specific scene that requires a high driving load on the driver, controller 23 can change the timing at which controller 23 causes the notifier to execute the power increase suppression control. In the above-described scene that requires a high driving load on the driver, controller 23 does not cause the notifier to notify the driver of the improvement method. When the scene that requires a high driving load on the driver ends, controller 23 can cause the notifier to notify the driver of the improvement method. When it is predicted that the vehicle drives into the scene that requires a high driving load on the driver, controller 23 can also cause the notifier to notify the driver of the improvement method in advance before the vehicle drives into the scene.

Also, controller 23 may store information that indicates whether the driver behavior has improved after notifying the driver of the proposed improvement method in storage 31 as a driver behavior history. As shown in FIG. 3B, in the behavior history, the driver behavior determined based on the driver behavior information by which the power consumption of the control unit has increased to be higher than the ideal power consumption, the proposed improvement method, and the driver behavior after notifying the driver of the proposed improvement method may be associated with each other for each scene. If it is determined that the driver behavior has improved, the improvement method is considered to be an improvement method that has shown an improvement effect. Accordingly, controller 23 may store the improvement method that has shown an improvement effect in the improvement method table to update the improvement method table.

Controller 23 may feed back the behavior history to the acquirer (for example, driver information acquirer 16). Then, identifier 22 may acquire the behavior history via the acquirer (for example, driver information acquirer 16), and identify, by further taking the behavior history into consideration, a scene in which, due to the driver behavior after notifying the driver of the proposed improvement method, the power consumption of the control unit is predicted to increase to be higher than the ideal power consumption. Identifier 22 may also predict, by further taking the route information included in the ECU information and the behavior history into consideration, a scene in which, due to the driver behavior, the power consumption of the control unit is predicted to increase to be higher than the ideal power consumption.

Also, controller 23 may propose an improvement method for improving the driver behavior in the scene in which the power consumption of the control unit is predicted to increase to be higher than the ideal power consumption by taking the behavior history into consideration. For example, in an identical or similar scene, controller 23 may determine whether the driver behavior has improved by the previously proposed improvement method. If it is determined that the driver behavior has not improved by the previously proposed improvement method, controller 23 may propose a different improvement method to the driver.

Also, the power increase suppression control includes control that optimizes the power consumption of the control unit in the scene identified by identifier 22. Controller 23 can execute the control that optimizes the power consumption. For example, controller 23 optimizes the power consumption of the control unit so as to suppress a predicted increase in the power consumption of the control unit in a scene in which, due to the driver behavior, the power consumption of the control unit is predicted to increase to be higher than the ideal power consumption. The optimization of the power consumption of the control unit is performed by, for example, distributing the processing of the control unit or optimizing the heat dissipation ability of the control unit.

For example, in the case where a plurality of processing operations executed by the control unit overlap in a scene in which the power consumption of the control unit is predicted to increase to be higher than the ideal power consumption, by controller 23 distributing the processing operations on the time axis to process the processing operations, it is possible to prevent the processing operations executed by the control unit from concentrating in the scene.

For example, controller 23 can optimize the heat dissipation ability of the control unit by assigning high-load processing to a control unit that has a high heat dissipation performance. Specifically, controller 23 can assign high-load processing to a control unit that has a high heat dissipation performance by controlling the cooling ability of at least one of a cooling fan, a water cooler, a water pump, or a peltier element for cooling the control unit. At this time, controller 23 controls the cooling ability of the control unit by adjusting the driving force (fan speed) of the cooling fan, the driving force (fan speed) of a cooling fan of a radiator included in the water cooler, the driving force (rotational speed) of the water pump, or the amount of electric current supplied to the peltier element.

Also, controller 23 can also optimize the heat dissipation ability of the control unit based on the cabin sensor information. The in-vehicle equipment provided in the vehicle is used more frequently as the number of passengers on the vehicle increases, and thus controller 23 may optimize the heat dissipation ability of the control unit by taking the cabin sensor information into consideration.

Also, controller 23 can feed back, to the acquirer, the power consumption of the control unit when notified the driver of the proposed improvement method and the current power consumption of the control unit when optimized. That is, controller 23 can output the current power consumption of the control unit to the acquirer. In this case, identifier 22 may acquire the current power consumption of the control unit fed back via the acquirer, and identify a scene in which the power consumption of the control unit that corresponds to the driver behavior is predicted to increase to be higher than the ideal power consumption by further taking the current power consumption of the control unit into consideration. Then, controller 23 may execute the power increase suppression control.

Storage 31 stores the improvement method table for improving the driver behavior while driving the vehicle. Storage 31 may store, in time series, the driver behavior information, the vehicle information, and the surroundings information acquired by the above-described acquirer. In addition, storage 31 also stores the behavior history. In addition, storage 31 may also store a computer program executed by processor 20, and the like. Storage 31 is implemented using, for example, a semiconductor memory.

Power supply battery 32 can supply driving power to processor 20, the above-described acquirer, and the like. Power supply battery 32 is, for example, a secondary battery, but may be a capacitor or the like.

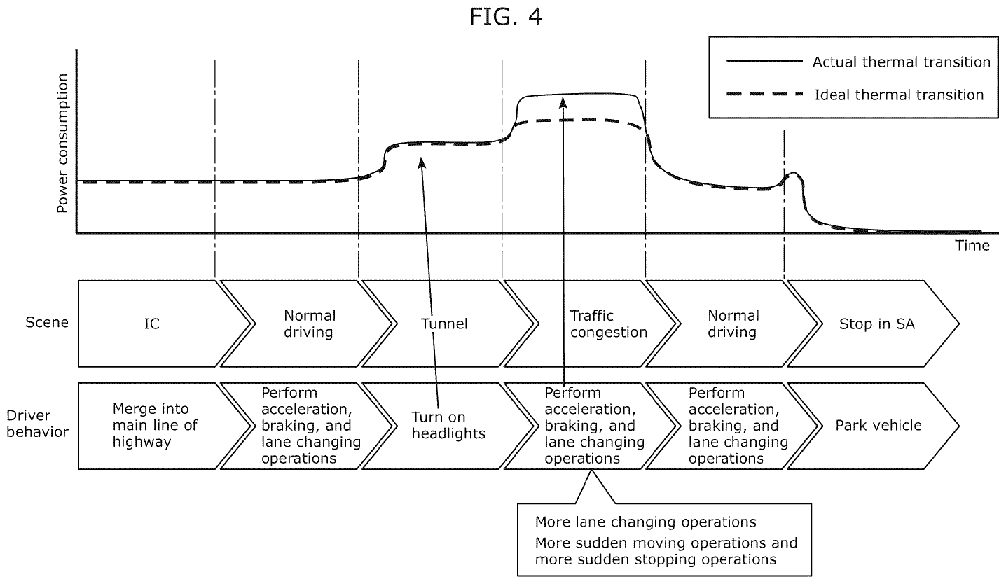

Next, the prediction of the power consumption performed when the vehicle drives on a highway will be described with reference to FIG. 4.

FIG. 4 is a diagram showing a relationship between the scene in which the vehicle drives, the driver behavior, and the power consumption of the control unit. In FIG. 4, a solid line indicates the power consumption of the control unit in certain scenes in which the vehicle has actually driven, and a broken line indicates the ideal power consumption of the control unit in the certain scenes. First, when the vehicle enters an interchange, which is one scene, and then merges into the main line of a highway to perform normal driving, which is one scene, the driver changes lanes by performing acceleration and braking operations. Each of the scenes indicated by “interchange (IC)” and “normal driving” is an example of one scene. At this time, the power consumption of the control unit during actual driving and the ideal power consumption of the control unit are about the same.

After that, when the vehicle enters a tunnel, the driver turns on the headlights of the vehicle. The scene indicated by “tunnel” is an example of one scene. When the vehicle enters a tunnel, the headlights of the vehicle is turned on, and the resolution of the in-vehicle camera decreases to increase the amount of image processing, and thus the power consumption of the control unit increases. However, the power consumption of the control unit during actual driving and the ideal power consumption of the control unit are about the same.

Furthermore, when the vehicle is involved in a traffic congestion, the driver changes lanes by performing acceleration and braking operations. The scene indicated by “traffic congestion” is an example of one scene. In this case, the number of driving control operations increases to increase the amount of processing of the infotainment-related control unit provided in the vehicle, and the amount of communication of the vehicle also increases to increase the power consumption of the control unit. However, the power consumption of the control unit during actual driving is higher than the ideal power consumption of the control unit.

When the vehicle gets out of the traffic congestion, and returns to normal driving, the driver changes lanes by performing acceleration and braking operations. In this case, the power consumption of the control unit decreases, and the power consumption of the control unit returns to the power consumption level during normal driving. However, the power consumption of the control unit during actual driving and the ideal power consumption of the control unit are about the same.

Then, the driver parks the vehicle in a service area. The scene indicated by “stop in service area (SA)” is an example of one scene. Because the number of driving control operations increases, the power consumption of the control unit is higher than the ideal power consumption. However, because the vehicle is parked in the service area, the power consumption of the control unit decreases to 0. In this case, the power consumption of the control unit during actual driving and the ideal power consumption of the control unit are about the same.

From the foregoing, with vehicle thermal management device 1, the vehicle thermal management method, and the program according to the present embodiment, it can be seen that the driver has a tendency of performing more sudden acceleration and braking operations and repeating sudden movements and sudden stops as well as lane changes in the “traffic congestion” scene that is one of a plurality of scenes including “interchange (IC)”, “normal driving”, “tunnel”, “traffic congestion”, and “stopping in service area (SA)” shown in FIG. 4 as examples.

For example, identifier 22 performs analysis by comparing the driver behavior history stored in storage 31 with the above-described fact that the driver has a tendency of performing more sudden acceleration and braking operations and repeating sudden movements and sudden stops as well as lane changes in the “traffic congestion” scene. If the driver behavior history in the past also includes the same behavior in the same scene, identifier 22 determines that the driver has a tendency of performing more sudden acceleration and braking operations and repeating sudden movements and sudden stops as well as lane changes in the “traffic congestion” scene.

In this case, based on the above-described result determined by identifier 22, controller 23 notifies, by controlling the notifier, the driver that the number of sudden movements and sudden stops, the number of lane changes, or the number of these operations increase when the vehicle is involved in a traffic congestion. Also, controller 23 determines, by controlling the notifier, a proposed improvement method for performing a gradual acceleration operation and a gradual braking operation when the vehicle is involved in a traffic congestion, also determine a proposed improvement method for reducing the number of lane changes when the vehicle is involved in a traffic congestion using the improvement method table stored in storage 31, and then notify the driver of the determined proposed improvement methods.

Also, controller 23 causes the notifier to notify the driver of the proposed improvement methods at a timing such as before driving the vehicle, before the vehicle drives into a scene in which the power consumption of the control unit is predicted to increase, or after driving the vehicle.

The driver makes an effort to perform a gradual acceleration operation and a gradual braking operation when the vehicle is involved in a traffic congestion, or reduce the number of lane changes when the vehicle is involved in a traffic congestion in accordance with the proposed improvement methods notified from the notifier. Accordingly, it can be expected that the power consumption of the control unit while the vehicle is driving will be reduced.

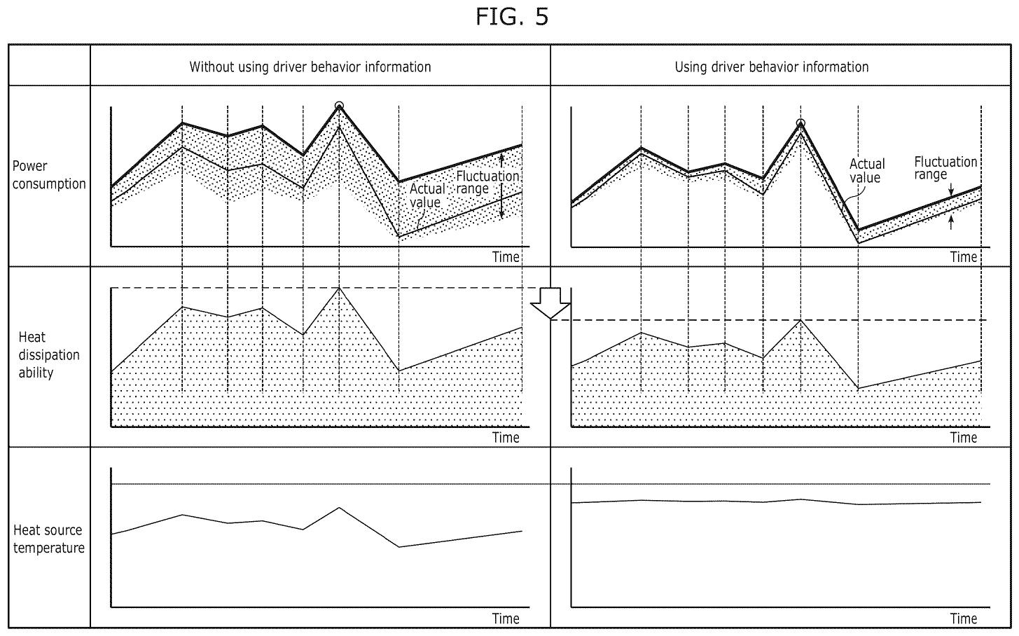

Next, differences between the power consumption, the heat dissipation ability, and the heat source temperature of the control unit according to a comparative example and the power consumption, the heat dissipation ability, and the heat source temperature of the control unit according to the present embodiment will be described with reference to FIG. 5.

FIG. 5 is a diagram showing the power consumption, the heat dissipation ability, and the heat source temperature according to a comparative example and the power consumption, the heat dissipation ability, and the heat source temperature according to the present embodiment. The comparative example corresponds to the case where the driver behavior information as in the present embodiment is not taken into consideration. The power consumption of the control unit during actual driving is indicated by a solid line. The fluctuation range of the power consumption of the control unit predicted to fluctuate due to the driver behavior is shown by hatching.

For example, in the power consumption shown in FIG. 5, in the comparative example, the hatched area (the fluctuation range of the power consumption of the control unit) tends to be large with respect to the solid line. The reason is considered to be that the predicted value varies greatly depending on the driver behavior.

On the other hand, in the present embodiment, as compared with the comparative example, the hatched area (the fluctuation range of the power consumption of the control unit) tends to be small with respect to the solid line. The reason is considered to be that the fluctuation range of the power consumption of the control unit during actual driving is unlikely to be large because identifier 22 identifies the scene in which the power consumption of the control unit is predicted to increase to be higher than the ideal power consumption by taking the driver behavior information into consideration.

For example, the heat dissipation ability shown in FIG. 5 must guarantee the heat dissipation ability at the maximum value of the fluctuation range of the power consumption of the control unit. For this reason, in the comparative example, the maximum value of the fluctuation range of the power consumption shown in FIG. 5 is the heat dissipation ability. In this case, the heat source temperature of the control unit is less than or equal to a safety criteria parameter, but the heat dissipation ability of the control unit is excessively increased. For this reason, in the comparative example, the power consumption of vehicle thermal management device 1 increases to reduce the energy efficiency of vehicle thermal management device 1, and thus sufficient energy saving of the vehicle cannot be achieved.

The safety criteria parameter used here includes a junction temperature, a maximum surroundings temperature, an overheating protection reference value, and a maximum heat transfer amount of that satisfy the safety criteria of the control unit. The junction temperature is a safety criteria parameter that requires that the heat source temperature of the control unit should not exceed a first predetermined temperature.

On the other hand, in the present embodiment, the maximum value of the fluctuation range of the power consumption shown in FIG. 5 is smaller than that of the comparative example. Accordingly, the heat dissipation ability of the control unit can be suppressed. Although the heat source temperature of the control unit is less than or equal to the safety criteria parameter as in the comparative example, the heat dissipation ability of the control unit is not excessively increased. For this reason, in the present embodiment, the increase in the power consumption of vehicle thermal management device 1 is suppressed to improve the energy efficiency of vehicle thermal management device 1, and thus sufficient energy saving of the vehicle can be achieved.

Controller 23 may predict the fluctuation range of the power consumption of the control unit using a data table that shows a correlation between the driver behavior information, the vehicle information, and the surroundings information. Controller 23 may predict the heat dissipation ability using a learning model that has been trained to predict the fluctuation range of the power consumption of the control unit from the driver behavior information, the vehicle information, and the surroundings information.

### <Example of Operation>

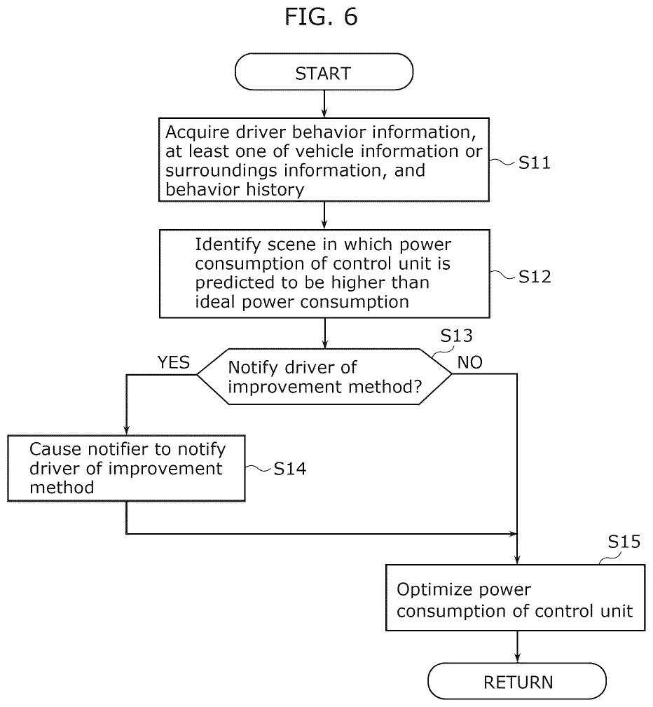

Next, an operation performed by vehicle thermal management device 1, the vehicle thermal management method, and the program according to the present embodiment will be described with reference to FIG. 6.

FIG. 6 is a flowchart illustrating an example of an operation performed by vehicle thermal management device 1.

First, the acquirer acquires the driver behavior information and at least one of the vehicle information or the surroundings information (S11). For example, surrounding environment detector 11 that is an example of an acquirer can acquire the obstacle information and the environment temperature information included in the surroundings information. Also, cabin situation detector 12 that is an example of an acquirer can acquire the cabin sensor information included in the vehicle information. Also, ECU information acquirer 13 that is an example of an acquirer can acquire the ECU information included in the vehicle information. Also, thermal control information acquirer 14 that is an example of an acquirer can acquire the thermal control information included in the vehicle information. Driver information acquirer 16 that is an example of an acquirer can detect the behavior of the driver in the cabin, and acquire the driver behavior information that indicates the behavior of the driver driving the vehicle. Also, driver information acquirer 16 can also acquire the behavior history from storage 31. Also, communicator 15 that is an example of an acquirer can acquire the environment t information and the driving environment information included in the surroundings information.

Next, identifier 22 identifies, based on the driver behavior information, at least one of the vehicle information or the surroundings information, and the behavior history, a scene in which the power consumption of the control unit provided in the vehicle that corresponds to the driver behavior information is predicted to increase to be higher than the ideal power consumption (S12). Identifier 22 outputs, to controller 23, the identified scene in which the power consumption of the control unit is predicted to increase to be higher than the ideal power consumption, together with the driver behavior.

Next, controller 23 determines whether to cause the notifier to notify the driver of an improvement method to execute the power increase suppression control for suppressing an increase in the power consumption of the control unit in the scene identified by identifier 22 in which the power consumption of the control unit is predicted to increase to be higher than the ideal power consumption (S13).

If the power consumption of the control unit is predicted to increase to be higher than the ideal power consumption due to the driver behavior determined based on the driver behavior information, controller 23 determines to cause the notifier to execute the power increase suppression control (to cause the notifier to notify the driver of an improvement method) (YES in S13). In this case, controller 23 controls the notifier to notify the driver of the identified scene in which the power consumption of the control unit is predicted to increase to be higher than the ideal power consumption and the driver behavior that corresponds to the identified scene. In addition, controller 23 also controls the notifier to determine an improvement method that corresponds to the scene in which the power consumption of the control unit is predicted to increase to be higher than the ideal power consumption from the improvement method table stored in storage 31 in advance for each scene. Then, controller 23 causes the notifier to notify the driver of the improvement method suitable for the determined scene in which the power consumption of the control unit is predicted to increase to be higher than the ideal power consumption (S14).

Because the scene in which the power consumption of the control unit is predicted to increase to be higher than the ideal power consumption, the driver behavior that corresponds to the scene, and the improvement method are notified to the driver, the driver can recognize which behavior needs to be improved. Accordingly, the driver makes an effort in accordance with the improvement method notified from the notifier, and thus the driver can improve the behavior in the scene in which the power consumption of the control unit is predicted to increase to be higher than the ideal power consumption.

Controller 23 stores, in storage 31, the driver behavior history that includes information that indicates whether the driver behavior has been improved after notifying the driver of the proposed improvement method by acquiring the driver behavior from driver information acquirer 16. Also, controller 23 feeds back the behavior history to driver information acquirer 16.

Next, controller 23 optimizes the power consumption of the control unit so as to suppress an increase in the power consumption of the control unit in the scene in which, due to the driver behavior, the power consumption of the control unit is predicted to increase to be higher than the ideal power consumption (S15).

By optimizing the power consumption of the control unit provided in the vehicle as described above, it is also possible to prevent the heat dissipation ability from excessively increasing while preventing the control unit to be heated to a high temperature.

Then, vehicle thermal management device 1 returns the processing of the flowchart shown in FIG. 6 to step S11.

On the other hand, if the power consumption of the control unit is predicted to not increase to be higher than the ideal power consumption due to the driver behavior determined based on the driver behavior information, controller 23 determines to optimize the power consumption of the control unit provided in the vehicle (to cause the notifier to not notify the driver of the improvement method) (NO in S13). In this case, controller 23 performs the processing of step S15.

Then, vehicle thermal management device 1 returns the processing of the flowchart shown in FIG. 6 to step S11.

Vehicle thermal management device 1 may include a determiner that determines, in step S13, whether to output the proposed improvement method or whether to execute the optimization. For example, if the amount of information in the behavior history stored in the storage is less than or equal to a predetermined information amount, the determiner may determine to execute the optimization. On the other hand, if the amount of information in the behavior history stored in the storage is greater than the predetermined information amount, the determiner may determine to notify the driver of the improvement method. Controller 23 may perform the processing of the determiner.

Also, the determiner may acquire the identified scene in which the power consumption of the control unit is predicted to increase to be higher than the ideal power consumption and the driver behavior from identifier 22. For example, if the notifier has already notified the driver of an improvement method for a specific scene, the determiner may determine to execute the optimization. If the notifier has not notified the driver of an improvement method for a different scene, the determiner may determine to notify the driver of the improvement method. That is, the determiner may first determine, for each scene, to notify the driver of an improvement method, and then determine to execute the optimization when the power increase suppression control is to be executed. As described above, the determiner may control the frequency of notification to the driver by executing power increase suppression control different from that executed previously.

### <Actions and Advantageous Effects>

Next, actions and advantageous effects of vehicle thermal management device 1, the vehicle thermal management method, and the program according to the present embodiment will be described.

However, according to the conventional technique disclosed in PTL 1, the load state of the engine cooling system is predicted, but there are cases where the prediction is insufficient. Accordingly, the conventional technique disclosed in PTL 1 is problematic in that it is not possible to sufficiently perform heat dissipation control on the control unit provided in the vehicle.

To address this, as described above, vehicle thermal management device 1 according to technique 1 of the present embodiment includes: an acquirer that acquires driver behavior information that indicates a driver behavior of a driver that is related to a driving operation of a vehicle and at least one of vehicle information that indicates a state of the vehicle or surroundings information regarding surroundings of the vehicle; identifier 22 that identifies, based on the driver behavior information and the at least one of the vehicle information or the surroundings information, a scene in which a power consumption of a control unit provided in the vehicle that corresponds to the driver behavior information is predicted to increase to be higher than an ideal power consumption; and controller 23 that executes power increase suppression control for suppressing an increase in the power consumption of the control unit in the scene identified by identifier 22 in which the power consumption of the control unit is predicted to increase to be higher than the ideal power consumption.

With this configuration, a scene in which, due to the driver behavior, the power consumption of the control unit is predicted to increase to be higher than the ideal power consumption can be identified, and it is therefore possible to execute the power increase suppression control on the identified scene.

Accordingly, with vehicle thermal management device 1 configured as described above, it is possible to more optimally perform heat dissipation control on the control unit provided in the vehicle.

Also, vehicle thermal management device 1 according to technique 2 of the present embodiment is vehicle thermal management device 1 according to technique 1 that further includes a notifier, wherein the power increase suppression control includes control that causes the notifier to notify the driver of a proposed improvement method to improve the driver behavior in the scene identified by identifier 22 in which the power consumption of the control unit is predicted to increase to be higher than the ideal power consumption, and controller 23 causes the notifier to execute the power increase suppression control.

With this configuration, it is possible to notify the driver of the proposed improvement method for improving the driver behavior in the scene in which, due to the driver behavior, the power consumption of the control unit is predicted to increase to be higher than the ideal power consumption. Accordingly, the driver comes to try to improve his/her behavior in accordance with the proposed improvement method notified from the notifier. It can therefore be expected that the driver will try to improve his/her behavior in the scene in which the power consumption of the control unit is predicted to increase to be higher than the ideal power consumption. As a result, it can be expected that the power consumption of the control unit while the vehicle is driving will be reduced.

Also, vehicle thermal management device 1 according to technique 3 of the present embodiment is vehicle thermal management device 1 according to technique 1 or 2. In this case, the power increase suppression control includes control that optimizes the power consumption of the control unit in the scene identified by identifier 22.

With this configuration, it is also possible to prevent the heat dissipation ability from excessively increasing while preventing the control unit to be heated to a high temperature. As a result, it can be expected that the power consumption of the control unit while the vehicle is driving will be reduced.

Also, vehicle thermal management device 1 according to technique 4 of the present embodiment is vehicle thermal management device 1 according to technique 2. In this case, when the scene identified by the identifier is a scene that requires a high driving load on the driver, controller 23 changes a timing at which controller 23 causes the notifier to execute the power increase suppression control.

For example, the driver is concentrating on driving while driving in a scene that requires a high driving load. Accordingly, even if the notifier notifies the driver of the improvement method at this timing, the driver may not be able to recognize the improvement method, and safety may not be able to be sufficiently ensured.

However, in the present embodiment, the improvement method is not notified to the driver while driving in a scene that requires a high driving load, and the improvement method is notified to the driver at a different timing. Accordingly, a situation is unlikely to occur where the driver does not recognize the notified improvement method, and thus the driver can recognize the notified improvement method.

Also, the frequency of notification can also be changed by changing the timing at which the notification is sent to the driver. For example, the frequency of notification can be reduced such that the driver does not feel annoyed. In this way, it is possible to prevent the driver from being disturbed in concentrating on driving. Also, vehicle thermal management device 1 according to technique 5 of the present embodiment is vehicle thermal management device 1 according to technique 2 or 4. In this case, controller 23 stores, in storage 31, a behavior history in which the driver behavior based on the driver behavior information by which the power consumption of the control unit has increased to be higher than the ideal power consumption, the proposed improvement method, and the driver behavior after the notifier has notified the driver of the proposed improvement method are associated with each other.

With this configuration, it is possible to know whether the notified improvement method has shown an improvement effect for the driver behavior, and thus the improvement method notified to the driver can be changed based on the improvement effect. Accordingly, it is possible to encourage the driver to improve his/her behavior.

Also, vehicle thermal management device 1 according to technique 6 of the present embodiment is vehicle thermal management device 1 according to technique 5. In this case, identifier 22 identifies the scene in which the power consumption of the control unit is predicted to increase to be higher than the ideal power consumption by further taking the behavior history into consideration.

With this configuration, by further taking the driver behavior history in the past into consideration, identifier 22 can more accurately identify the scene in which, due to the driver behavior, the power consumption of the control unit is predicted to increase to be higher than the ideal power consumption.

Also, vehicle thermal management device 1 according to technique 7 of the present embodiment is vehicle thermal management device 1 according to technique 6. In this case, controller 23 executes the power increase suppression control for suppressing an increase in the power consumption of the control unit by further taking the behavior history into consideration.

With this configuration, controller 23 can more accurately calculate the amount of increase in the power consumption of the control unit by further taking the behavior history into consideration. Accordingly, it is possible to accurately predict the power consumption of the control unit so as to reduce the fluctuation range of the power consumption of the control unit.

Also, a vehicle thermal management method according to technique 8 of the present embodiment includes: by an acquirer, acquiring driver behavior information that indicates a driver behavior of a driver that is related to a driving operation of a vehicle and at least one of vehicle information that indicates a state of the vehicle or surroundings information regarding surroundings of the vehicle; by identifier 22, identifying, based on the driver behavior information and at least one of the vehicle information or the surroundings information, a scene in which a power consumption of a control unit provided in the vehicle that corresponds to the driver behavior information is predicted to increase to be higher than an ideal power consumption; and by controller 23, executing power increase suppression control for suppressing an increase in the power consumption of the control unit in the scene identified by identifier 22 in which the power consumption of the control unit is predicted to increase to be higher than the ideal power consumption.

With this vehicle thermal management method as well, the same actions and advantageous effects as those described above can be obtained.

Also, a program according to technique 9 of the present embodiment is a program for causing a computer to execute the vehicle thermal management method according to technique 8.

With this program as well, the same actions and advantageous effects as those described above can be obtained.

### (Others)

Up to here, the vehicle thermal management device and the like according to one or more aspects of the present disclosure have been described above by way of an embodiment, but the present disclosure is not limited to the embodiment given above. Other embodiments obtained by making various modifications that can be conceived by a person having ordinary skill in the art to the above-described embodiment without departing from the scope of the present disclosure are also included within the scope of the one or more aspects of the present disclosure.

For example, in the vehicle thermal management device and the like described above, all or some of the structural elements such as processors may be implemented using dedicated hardware or may be implemented by executing a software program suitable for the structural elements. The structural elements may be implemented by a program executor such as a central processing unit (CPU) or a processor reading and executing a software program recorded in a recording medium such as a hard disk drive (HDD) or a semiconductor memory.

Also, the functional blocks shown in the block diagrams are merely examples. Accordingly, it is possible to implement a plurality of functional blocks as a single functional block, or divide a single functional block into a plurality of blocks. Alternatively, some functions may be transferred to other functional blocks. Also, the functions of a plurality of functional blocks that have similar functions may be processed by a single piece of hardware or software in parallel or by time division.

Also, the order of steps performed in each of the flowcharts is merely an example to specifically describe the present disclosure. Accordingly, the order of steps in each of the flowcharts may be different from those described above. Also, some of the steps may be performed simultaneously (in parallel) with the other steps.

The present disclosure also encompasses other embodiments obtained by making various modifications that can be conceived by a person having ordinary skill in the art to the above-described embodiment as well as embodiments implemented by any combination of the structural elements and the functions of the above-described embodiment without departing from the scope of the present disclosure.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in their entirety: Japanese Patent Application No. 2024-056228 filed on Mar. 29, 2024.

### INDUSTRIAL APPLICABILITY

The vehicle thermal management device and the like according to the present disclosure can be mounted on a vehicle.

1. A vehicle thermal management device comprising:
an acquirer that acquires driver behavior information that indicates a driver behavior of a driver that is related to a driving operation of a vehicle and at least one of vehicle information that indicates a state of the vehicle that the driver drives or surroundings information regarding surroundings of the vehicle;
an identifier that identifies, based on the driver behavior information and the at least one of the vehicle information or the surroundings information, a scene in which a power consumption of a control unit provided in the vehicle that corresponds to the driver behavior information is predicted to increase to be higher than an ideal power consumption; and
a controller that executes power increase suppression control for suppressing an increase in the power consumption of the control unit in the scene that is identified by the identifier and in which the power consumption of the control unit is predicted to increase to be higher than the ideal power consumption.

2. The vehicle thermal management device according to claim 1, further comprising:
a notifier,
wherein the power increase suppression control includes control that causes the notifier to notify the driver of a proposed improvement method to improve the driver behavior in the scene that is identified by the identifier and in which the power consumption of the control unit is predicted to increase to be higher than the ideal power consumption, and
the controller causes the notifier to execute the power increase suppression control.

3. The vehicle thermal management device according to claim 1,
wherein the power increase suppression control includes control that optimizes the power consumption of the control unit in the scene identified by the identifier.

4. The vehicle thermal management device according to claim 2,
wherein, when the scene identified by the identifier is a scene that requires a high driving load on the driver, the controller changes a timing at which the controller causes the notifier to execute the power increase suppression control.

5. The vehicle thermal management device according to claim 2,
wherein the controller stores, in a storage, a behavior history in which the driver behavior based on the driver behavior information by which the power consumption of the control unit has increased to be higher than the ideal power consumption, the proposed improvement method, and the driver behavior after the notifier has notified the driver of the proposed improvement method are associated with each other.

6. The vehicle thermal management device according to claim 5,
wherein the identifier identifies the scene in which the power consumption of the control unit is predicted to increase to be higher than the ideal power consumption by further taking the behavior history into consideration.

7. The vehicle thermal management device according to claim 6,
wherein the controller executes the power increase suppression control for suppressing an increase in the power consumption of the control unit by further taking the behavior history into consideration.

8. A vehicle thermal management method comprising:
by an acquirer, acquiring driver behavior information that indicates a driver behavior of a driver that is related to a driving operation of a vehicle and at least one of vehicle information that indicates a state of the vehicle or surroundings information regarding surroundings of the vehicle;
by an identifier, identifying, based on the driver behavior information and at least one of the vehicle information or the surroundings information, a scene in which a power consumption of a control unit provided in the vehicle that corresponds to the driver behavior information is predicted to increase to be higher than an ideal power consumption; and
by a controller, executing power increase suppression control for suppressing an increase in the power consumption of the control unit in the scene that is identified by the identifier and in which the power consumption of the control unit is predicted to increase to be higher than the ideal power consumption.

9. A non-transitory computer-readable recording medium having recorded thereon a program for causing a computer to execute the vehicle thermal management method according to claim 8.
